(19) United States
(12) Patent Application Publication
(10) Pub. No.: US 2011/0073799 A1
(43) Pub. Date: Mar. 31, 2011

(54) THERMALLY CONDUCTIVE POLYMER COMPOSITIONS

(76) Inventor: Eric Magni, Levis (CA)

(21) Appl. No.: 12/894,300

(22) Filed: Sep. 30, 2010

Related U.S. Application Data
(60) Provisional application No. 61/247,188, filed on Sep. 30, 2009.

(51) Int. Cl. C09K 5/00; B82Y 30/00

(52) U.S. Cl. 252/75; 252/73; 252/74; 252/76; 977/734

(57) ABSTRACT

A thermally conductive polymer composition, comprising a polymer, conductive charges in an amount of about 35% by weight or less, and a compatibilizer, the composition having a transverse thermal conductivity of about 0.5 W/m/K or more and a deformation at break of about 850% or less The composition is fabricated by i) feeding a polymer and a compatibilizer in a feed zone of an extruder to obtain a melted resin; ii) introducing directly into the extruder downstream of the feed zone, conductive charges in an amount of about 35% by weight or less into the melted resin; and iii) providing a degassing zone before the output of the thermally conductive polymer composition produced.

### CROSS REFERENCE TO RELATED APPLICATIONS

This application claims benefit of U.S. provisional application Ser. No. 61/247,188, filed on Sep. 30, 2009. All documents above are incorporated herein in their entirety by reference.

### FIELD OF THE INVENTION

The present invention relates to conductive polymers. More specifically, the present invention is concerned with a composition for thermally conductive polymers.

### BACKGROUND OF THE INVENTION

Thermally conductive polymer compositions for dissipating heat are of interest in a number of applications, such as, for example, microelectronic devices such as semiconductors, microprocessors, resistors, circuit boards and integrated circuit elements. Thermally conductive polymer compositions are also used to make motor parts, lighting fixtures, optical heads, medical devices, and components for use in conjunction with a number of products.

The low bulk density of the thermally conductive fillers that are typically used proves quite difficult to handle creating a limitation on the total percentage of solids that can be introduced and reducing the actual line production speed. Further, these small particles may cause the resin to dust, thereby leading to handling and clean-up problems. In addition, if thermally conductive fillers having a relatively large particulate size are used, there can be problems with the bulk-density of the resins. For example, it may be difficult to add thermally conductive fillers having relatively large geometric shapes and structures to the base resin at loadings greater than about 40 to about 50% by weight. Further, such high loading ratios make the final processing of such resins difficult, thereby limiting the throughput rate of the compounding machines to a point that the machines may operate at only 50% capacity in some instances.

Moreover, it is often difficult to completely and uniformly disperse the thermally conductive fillers throughout the base polymer because of the chemical structure of these fillers. For example, boron nitride and graphite particles have inert surfaces that cause these fillers to be difficult to wet out and disperse in a base polymer. This is particularly the case when graphite or boron nitride fillers are incorporated into thermoplastic base resins. Thus, it can be difficult to add these thermally conductive fillers in large amounts to the composition. Frequently, because these fillers lack an affinity for traditional thermoplastic resins, when they are incorporated at high filler loadings, the filler material has the tendency to clump. Further, even if the filler is ultimately uniformly dispersed, the filler material is not generally sufficiently wet out by the resin and adhesion between the inert surfaces of the filler particles and the thermoplastic resin tend to be poor. Additionally, when these high modulus thermally conductive fillers are added to a base polymer that also has a relatively high modulus, the modulus of the composition tends to increase, resulting in a more brittle composition. The resulting high modulus compositions may be molded to form an end-use product having good strength and rigidity; however, due to the nature of the filler material used, the product may be too brittle.

Different methods are used to measure thermal conductivity. Thermal diffusivity, α, of a medium is the thermophysical property that determines the speed of heat propagation by conduction during changes of temperature with time. The higher the thermal diffusivity, the faster the heat propagation. The thermal diffusivity is related to the thermal conductivity λ, specific heat Cₚ and density ρ as follows:

$$α = \frac{λ}{ρ {C}_{p}}$$

According to the above equation, the thermal diffusivity affects any conductive transient heat transfer process within the medium. It has the dimension of length²/time and is usually expressed in the unit m²/s.

A widely used method for measuring thermal diffusivity is the flash method, because it has the advantage of requiring very small samples, usually 12 mm diameter and a few millimeters thick, and of being fast (a few seconds). After a sample has been stabilized at a desired temperature T₀, a nearly instantaneous pulse of energy (usually laser or other discharge source) is applied on its front face, and the temperature increase DT(t) on the rear face of the sample is recorded as a function of time. Since this method assumes ideal conditions of an adiabatic sample and instantaneous pulse heating, it is somewhat limited in applicability. To make it more suitable to experimental conditions, other methods have been introduced in the art, which account for heat losses, finite pulse duration, non-uniform pulse heating and composite (non-homogeneous) structures.

Other methods, such as described by ASTM E1225-04 for example, measure the thermal conductivity across the thickness.

### SUMMARY OF THE INVENTION

More specifically, in accordance with the present invention, there is provided thermally conductive polymer composition, comprising a polymer, conductive charges in an amount of about 35% by weight or less, and a compatibilizer, the composition having a transverse thermal conductivity of about 0.5 W/m/K or more and a deformation at break of about 850% or less.

There is provided a method for making a thermally conductive polymer composition having a transverse thermal conductivity of about 0.5 W/m/K or more and a deformation at break of about 850% or less, comprising the steps of: i) feeding a polymer and a compatibilizer in a feed zone of an extruder to obtain a melted resin; ii) introducing directly into the extruder, downstream of the feed zone, conductive charges in an amount of about 35% by weight or less into the melted resin; and iii) providing a degassing zone before the output of the thermally conductive polymer composition produced.

There is further provided a heat exchanger, made in a polymer composition comprising a polymer, conductive charges in an amount of about 35% by weight or less, and a compatibilizer, the heat exchanger having a transverse thermal conductivity of about 0.5 W/m/K or more and a deformation at break of about 850% or less.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows mixing elements used between the static mixer and the extruder head during extrusion of test tubes;

FIG. 2 shows results of mechanical tests performed on test tubes of different compositions according to an embodiment of the present invention;

FIG. 3 shows the principle of a traction test on a ring of tube as used herein;

FIG. 4 show the principle of a Flex Kinkétest as used herein; a) the sample passes the test; b) the sample fails the test;

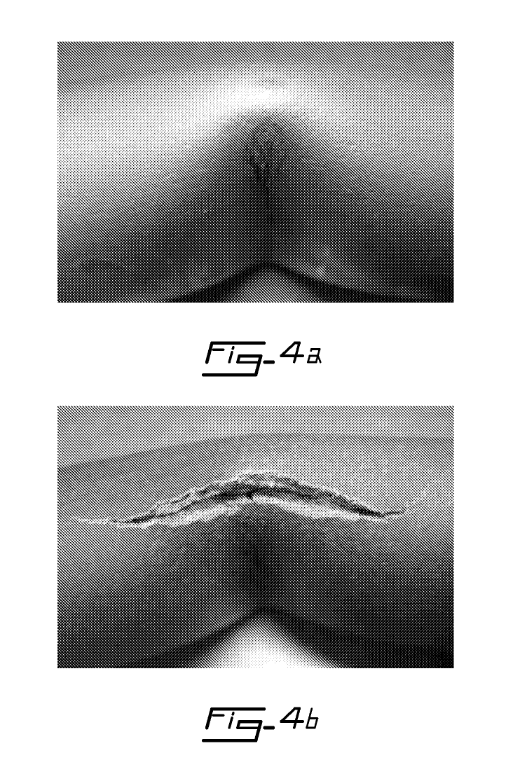

FIG. 5 shows the principle of stress-cracking resistance tests used herein; and

FIG. 6 shows the principle of deflection temperature tests used herein.

### DESCRIPTION OF ILLUSTRATIVE EMBODIMENTS

The present invention is illustrated in further details by the following non-limiting examples. All percentages are in terms of weight percent, except where otherwise indicated.

High-density polyethylene (HDPE) is used to make tubes for a range of applications because of its good resistance to corrosion, resistance to impact at low temperature and advantageous elastic properties, since this linear polyethylene has greater tensile strength and hardness than the low density variety, which have been tested in applications of water distribution networks for example. Other polymers may be contemplated, including for example low density polyethylene (LDPE), polypropylene (PP), poly(methyl methacrylate) (PMMA), polystyrene (PS), polyamide (PA), poly(butylene terephthalate) (PBT), polycarbonate (PC), acrylonitrile-butadiene-styrene copolymer (ABS), depending on cost limitations and desired performances and properties. At current material rates, polyolefins are preferred candidates.

The thermal conductivity of these polymers may be a limitation in a number of applications, such as in geothermal applications for example. In the case of HDPE, the thermal conductivity is of about 0.379 W/m/K.

It is possible to increase the thermal conductivity of these polymers by adding conductive charges thereto. A range of conductive charges may be contemplated, including, for example, metals, metal oxides, ceramics, minerals such as talc, and carbon materials, and also other fillers, such as for example, aluminum, copper, aluminum oxide, magnesium oxide, boron nitride, or graphite, and carbon black for example.

It is known that adding graphite into HDPE for example yields an increased thermal conductivity. As people in the art will appreciate, graphite comes in several forms, including flake graphite, densified/exfoliated graphite and exfoliated graphite. Flake graphite occurs as isolated, flat, plate-like particles with hexagonal edges if unbroken and when broken the edges can be irregular or angular. Exfoliated graphite comprises nanoparticles consisting of small stacks of graphene that are 1 to 15 nanometers thick, with diameters ranging from sub-micrometer to 100 micrometers.

According to an embodiment of an aspect of the present invention, conductive charges are selected and incorporated into a polymer so as to produce a conductive polymer having target mechanical properties.

In a first set of experiments, thermal conductivity measurements in the thickness (as defined by ASTM E1225-04) were taken on different compositions, including: prime HDPE as a reference, HDPE with graphite (KS150 7% and 15%), HDPE 21 with carbon black (7%, 15% and 30%), HDPE 21 with iron particles (7% and 15% of a primary blend of PP and 50% metallic particles, referred to hereinafter as SCHULMAN® MAG 7224), pristine nylons (PP), and nylons (PP) with carbon black (7% and 15% of a primary blend of nylon and 40% carbon black, referred to as CONC-99), as summarized in Table I below:

TABLE I

| | | Thermal |
|---|---|---|
| | Directly incorporated | conductivity in the |
| Polymer | conductive charges | thickness (W/m/K) |
| HDPE | None | 0.380 |
| HDPE | Graphite KS150 7% | 0.445 |
| HDPE | Graphite KS150 15% | 0.520 |
| HDPE-21 | 7% carbon black | 0.402 |
| HDPE-21 | 15% carbon black | 0.413 |
| HDPE-21 | 30% carbon black | 0.460 |
| HDPE-21 | 7% SCHULMAN ® MAG 7224 | 0.349 |
| HDPE-21 | 15% SCHULMAN ® MAG 7224 | 0.391 |
| NYLON | None | 0.280 |
| NYLON | None | 0.282 |
| NYLON ZYTEL ® 45HSB | 7% CONC-099 | 0.339 |
| de DuPont | | |
| NYLON ZYTEL ® 45HSB | 15% CONC-099 | 0.354 |
| de DuPont | | |
| NYLON ZYTEL ® 42A | 7% CONC-099 | 0.332 |
| de DuPont | | |
| NYLON ZYTEL ® 42A | 15% CONC-099 | 0.357 |
| de DuPont | | |

Table I above indicates the maximum thermal conductivities that can be achieved with loading polymers with charges as known in the art.

In a further set of experiments, test tubes of ½ inch diameter made in charged HDPE were extruded and tested. HDPE and compatibilizers were gravity fed from top mounted feed hoppers into the barrel of a co-rotating twin-screw 1″ extruder. As well known in the art, the material enters through a feed throat and comes into contact with the screws, which force the plastic beads forward into the barrel. A heating profile was set for the barrel to gradually increase the temperature of the barrel from the rear (where the plastic enters) to the front, thereby allowing the plastic beads to melt gradually as they are pushed through the barrel and lower the risk of overheating which may cause degradation in the polymer.

Conductive particles were introduced directly into the extruder, sidewise, downstream of the feed zone, into the melted resin. The screw configuration is designed around target operations that are to occur along the length thereof by selectively assembling conveying elements, reverse conveying elements, kneading blocks, and other elements in order to achieve desired mixing characteristics along each point of the co-rotating screws. A degassing zone was provided before the output of the produced pellets conveyed on a conveying mat. A white conveying mat allowed to verify that the conductive charges were well encapsulated into the polymer, since the pellets left no mark thereon.

Test tubes of ½ inch diameter were extruded using a 5 channels spinneret, straight on an air cooling mat, in order to avoid humidification of the conductive charges as might occur if pulling the extrudate through a water bath.

Different types of conductive charges and compatibilizers were tested, as summarized in Table II below:

TABLE II

| | | |
|---|---|---|
| Graphites | KS 150 | Density 0.42 |
| | KS 44 | Density 0.19 |
| | BNB90 | Density 0.03 |

| | |
|---|---|
| Compatibilizer | Polybond ® 3029 |
| | Struktol ® TR 060 |
| | Orevac ® 18307 or 18507 |
| | Optipak ® 200 |

Timcal® KS graphite grades are synthetic graphites, mostly used in thermoplastics, thermosets and elastomers, of an irregular spheroid shape. The thermal conductivity of KS graphites is announced as of 140 W/(m.K) (when pressed to density 2.2 g/cm³ at 25° C.). KS 150 is a fine black powder comprising 0.06% ash, 0.05% moisture, with a crystallite height higher than 100 nm, a tap density of 0.51 g/m³, a particle size ranging from 32 micrometers to 180 micrometers. KS 44 is a fine black powder of a particle size ranging from 6 micrometers to 48 micrometers, with a crystallite height higher than 200 nm and an interlayer distance in a range between 0.3354 and 0.3358 nm.

BNB 90 is a fine black powder of expanded graphite a particle size ranging from 10 micrometers to 85.2 micrometers, with a crystallite height of 35 nm and an interlayer distance of 0.3359 nm.

Polybond® 3029 is a maleic anhydride modified HDPE specifically designed for use as a coupling agent in wood and natural fiber-filled PE composites, which provides improved tensile, flexural and impact strengths as well as lower water absorption.

Struktol® TR 060 is a mixture of light-colored aliphatic resins with a molecular weight below 2,000, used as a blending aid processing additive in amounts between 0.5 and 1.0% because of its natural tackiness at process temperatures, in polymers where high filler levels require the most uniform blending in order to maintain physical properties, such as for example TPO compounds, flame retardant formulations, filled polymer systems and recycled PVC. In addition, the low molecular weight of Truktol® TR 060 provides some viscosity reduction during processing which improves flow.

Orevac® 18307 is a maleic anhydride grafted HDPE, known as an effective coupling agent in non-halogen flame retardant cable compounds using high loadings of mineral fillers. It provides an effective coupling between the base polymers (Evatane®, Lotryl®, various polyolefins) and the mineral fillers (Ath, Mdh).

Optipak® 200 is an additive used in for wood-plastic composites, to achieve enhanced physical properties, including a significant increase in flexural strength and up to a 30 percent decrease in moisture absorption according to the manufacturer (Honeywell).

Two HDPE grades were tested: HDPE 21 and HDPE 04, each having characteristics provided by the manufacturers as shown in Table III below.

TABLE III

| Parameters | HDPE 21 | HDPE 04 |
|---|---|---|
| MFI (5 kg at 190° C.) | 0.18 g/10 mins | 19 g/10 mins |
| Density | 0.947 g/cm³ | 0.952 g/cm³ |
| Tensile Strength | 31 MPa | 23.3 MPa |
| Impact (Izod) | 215 j/m | 52.8 j/m at −40c |
| Elongation at break | 7% | 48% |

As known in the art, the Melt Flow Index (MFI) is a measure of the ease of flow of the melt of a thermoplastic polymer, defined as the mass of polymer flowing in 10 minutes through a capillary of specific diameter and length by a pressure applied via prescribed alternative gravimetric weights for alternative prescribed temperatures (ASTM D1238 and; for Europe, see ISO 1133). As shown in Table IV below, it appears in the following that as the chains are shorter and the fluidity of the material increases, the material is increasingly thermally conductive.

The Izod impact test is the most common test to measure the impact resistance of plastics in North America (ASTM D256; for Europe see ISO 180). The result of the Izod test may be reported as energy lost per unit cross-sectional area. This measure is used to avoid using polymer materials that are sensitive to stress concentrations at a notch in designs which create high stress concentrations such as sharp corners or cutouts.

The elongation at break is the elongation recorded at the moment of rupture of the sample, expressed as a percentage of the original length. It corresponds to the breaking or maximum load.

In Table IV below, Pel refers to a LDPE, which is used to dilute the two HDPE grades. As can be seen from the table, this allowed incorporating conductive charges in increased amounts, while maintaining a homogeneous distribution thereof in the polymer.

TABLE IV

| | |
|---|---|
| Composition | Ref. PE compatibilizer |

| | | HDPE | Pel | Ref. graphite | | | | Struktol ® | | | |
|---|---|---|---|---|---|---|---|---|---|---|---|
| | | 04 | 01 | | KS | | Polybond ® | TR | Orevac ® | Optipak ® | Thermal |
| | HDPE | (%) | (%) | KS | 44 | BNB90 | 3029 | 060 | 18307 | 200 | conductivity |
| Ref. | 21 | 70 | 30 | 150. | (%) | (%) | (%) | (%) | (%) | (%) | W/mk |

| | | | | | | | | | |
|---|---|---|---|---|---|---|---|---|---|
| PGB10 | 90% | 10 | | | | | | | 0.404 |
| HG153 | 70% | 30 | | | | | | | 0.752 |
| HG153P | 68.50% | 30 | | | 1.50 | | | | 0.717 |
| HG153S | 68.50% | 30 | | | | 1.50 | | | 0.716 |
| HG153L | 67.50% | 30 | | | | | 2.50 | | 0.671 |
| HG153O | 67.00% | 30 | | | | | | 3.00 | 0.610 |
| HG443 | 70% | | 30 | | | | | | 0.455 |
| HG443P | 68.50% | | 30 | | 1.50 | | | | 0.442 |
| HG443S | 68.50% | | 30 | | | 1.50 | | | 0.470 |
| HG443L | 67.50% | | 30 | | | | 2.50 | | 0.471 |
| HG443O | 67.00% | | 30 | | | | | 3.00 | 0.455 |
| HG903 | 70% | | | 30 | | | | | 0.514 |
| HG903P | 68.50% | | | 30 | 1.50 | | | | 0.610 |
| HG903S | 68.50% | | | 30 | | 1.50 | | | 0520 |
| HG903L | 67.50% | | | 30 | | | 2.50 | | 0.615 |
| HG903O | 67.00% | | | 30 | | | | 3.00 | 0.600 |
| HNC73 | 70% | | | | | | | | 0.664 |
| HNC73P | 68.50% | | | | 1.50 | | | | 0.660 |
| HNC73S | 68.50% | | | | | 1.50 | | | 0.470 |
| HNC73L | 67.50% | | | | | | 2.50 | | 0.664 |
| HNC73O | 67.00% | | | | | | | 3.00 | 0.485 |
| HNCN3 | 70% | | | | | | | | 0.510 |
| HNCN3P | 68.50% | | | | 1.50 | | | | 0.664 |
| HNCN3S | 68.50% | | | | | 1.50 | | | 0.601 |
| HNCN3L | 67.50% | | | | | | 2.50 | | 0.662 |
| HNCN3O | 67.00% | | | | | | | 3.00 | 0.588 |
| HG1535 | 65 | 35 | | | | | | | 0.950 |
| HG153P | 63.5 | | 35 | | 1.50 | | | | 0.480 |
| HG153S | 63.5 | | | 35 | | 1.50 | | | 0.620 |
| HG1535L | 62.50 | | | 35 | | | 2.50 | | 0.671 |
| HG153O | 62.00 | | | | | | | 3.00 | 0.580 |

As can be seen from Table IV, different combinaiton of resins, types of graphite charges and compatibilizers allow a range of thermal conductivities.

It is found that maleic anhydride allows networking the flakes of exfoliated graphite (density 0.40) with the polymer, resulting in a good dispersion of the graphite, and in improved thermal conductivity along the chains and along the extrusion direction. Other compatibilizers may be contemplated, including for example calcium stearate and other dispersing agents such as pentaerythritol stearate for example. Lubricants used in bio-polymers may further be used to improve extrusion rate and appearance.

Impact modifiers, such as Vistamaxx™ for example, may further be added to increase impact resistance of the composite polymer. Vistamaxx™ is an olefinic based speciality elastomer produced by ExxonMobil Chemicals. It has excellent elastomeric properties, and is generally used to increase the toughness of PP-ethylene elastomer blends by incorporation of very low amounts thereof as a compatibilizer.

TABLE V

| | | | | | | Composition | | | | | | | | |
|---|---|---|---|---|---|---|---|---|---|---|---|---|---|---|
| | | | | | | % | | Graphite | | | | | | |
| | | | | | | Hdpe | Pel | KS | | | Coupling agents | | | |
| | | | Measured | | | 04 | 01 | 150 | KS | BNB | POLY | Struktol | | |
| Average K | Average K | Gain % | Density | Formula | MFI | 70% | 30% | % | 44 | 90 | 3029 | 60 | L18307 | Conc-099csa |

| | | | | | | | | | | | | | |
|---|---|---|---|---|---|---|---|---|---|---|---|---|---|
| 0.379 | 0.379 | | 0.9532 | 0PGB10 | 15.46 | 90 | 10 | | | | | | |
| 0.404 | 0.404 | 6.60 | 0.9962 | | | | | | | | | | |
| 0.752 | 0.752 | 98.42 | 1.1392 | 1HG153 | | 70 | 30 | | | | | | |
| 0.814 | 0.778 | 105.15 | 1.1700 | 1/AHG153 | 8.86 | 64 | 30 | | | | | | 6.5% |
| 0.741 | | | 1.1505 | 1/AHG153 | | | | | | | | | |
| 0.735 | 0.720 | 89.84 | 1.1460 | 1/1HG153 | | 70 | 30 | | | | | | |
| 0.704 | | | 1.1293 | 1/1HG153 | | | | | | | | | |
| 0.693 | 0.717 | 89.05 | 1.1590 | 2HG153P | 7.68 | 68.50 | 30 | | | 1.50% | | | |
| 0.740 | | | 1.1529 | 2HG153P | | | | | | | | | |
| 0.711 | 0.716 | 88.92 | 1.1590 | 3HG153S | 9.17 | 68.50 | 30 | | | | 1.50% | | |
| 0.721 | | | 1.1562 | 3HG153S | | | | | | | | | |
| 0.753 | 0.772 | 103.69 | 1.1600 | 4HG153L | 5.75 | 67.50 | 30 | | | | | 2.50% | |
| 0.791 | | | 1.1388 | 4HG153L | | | | | | | | | |
| 0.637 | 0.671 | 77.04 | 1.1560 | 4/1HG153L | | 67.50 | 30 | | | | | 2.50% | |
| 0.705 | | | 1.1556 | 4/1HG153L | | | | | | | | | |
| 0.735 | 0.678 | 78.89 | 1.1530 | 4/AHG153L | | 61.00 | 30 | | | | | 2.50% | 6.5% |
| 0.621 | | | 1.1569 | 4/AHG153L | | | | | | | | | |
| 0.478 | 0.455 | 20.05 | 1.0430 | 6HG443 | 13.92 | 87 | | 13% | | | | | |
| 0.432 | | | 1.0455 | 6HG443 | | | | | | | | | |
| 0.443 | 0.442 | 16.49 | 1.0260 | 7HG443P | 12.51 | 85.50 | | 13% | | 1.50% | | | |
| 0.440 | | | 1.0285 | 7HG443P | | | | | | | | | |
| 0.480 | 0.470 | 24.01 | 1.0260 | 8HG443S | 15.11 | 88.50 | | 13% | | | 1.50% | | |
| 0.460 | | | 1.0319 | 8HG443S | | | | | | | | | |
| 0.430 | 0.470 | 23.88 | 0.8800 | 9HG443L | 10.18 | 87.50 | | 13% | | | | 2.50% | |
| 0.509 | | | 1.0255 | 9HG443L | | | | | | | | | |
| 0.512 | 0.514 | 35.49 | 0.9830 | 11HG903 | 11.72 | 95.00 | | | 5% | | | | |
| 0.515 | | | 0.9836 | 11HG903 | | | | | | | | | |
| 0.485 | 0.485 | 27.97 | 1.0050 | 16HNC73 | 10.93 | 90.0 | | | | | | | |
| 0.634 | 0.664 | 75.20 | 1.1120 | 20AHNC73L | 1.67 | 72.50 | 15 | | | | | 2.50% | |
| 0.694 | | | 1.1043 | 20AHNC73L | | | | | | | | | |
| 0.608 | 0.601 | 58.44 | 1.0810 | 20CHNC73L | 0.194 | 72.00 | 20 | | | | | 3.00% | |
| 0.593 | | | 1.0905 | 20CHNC73L | | | | | | | | | |
| 0.439 | 0.480 | 26.52 | 1.0230 | 21HNCN3 | 3.1 | 95 | | | | | | | |
| 0.520 | | | 0.9999 | 21HNCN3 | | | | | | | | | |
| 0.443 | 0.452 | 19.26 | 1.0060 | 21AHNCN3 | 17.78 | 90 | | | | | | | |
| 0.461 | | | 1.0214 | 21AHNCN3 | | | | | | | | | |
| 0.530 | 0.524 | 38.26 | 1.0980 | 21BHNCN3 | 0.383 | 85 | | | | | | | |
| 0.518 | | | 1.0444 | 21BHNCN3 | | | | | | | | | |
| 0.518 | 0.516 | 36.15 | 1.0460 | 24HNCN3L | 0.368 | 82.50 | | | | | | 2.50% | |
| 0.514 | | | 1.0321 | 24HNCN3L | | | | | | | | | |
| 0.498 | 0.523 | 37.86 | 1.0430 | 24AHNCN3L | 0.295 | 83.50 | | | | | | 1.50% | |
| 0.547 | | | 1.0436 | 24AHNCN3L | | | | | | | | | |
| 0.877 | 0.788 | 107.92 | 1.2000 | 32HG1535 | 7.2 | 65 | 35 | | | | | | |
| 0.699 | | | 1.1252 | 32HG1535 | | | | | | | | | |

The tests were started with the OPGB10 formula (HDPE 21 with 10% KS 150), as a reference, since it had been previously tested for thermal conductivity at 0.404 W/m/K.

KS150 graphite yielded the best results. For KS44 and BNB90, their low density (see Table II above) did not allow incorporating the target load with the two small screws used. Still, BNB90, at a load of 5%, yielded an increase of 35.88%, while KS150 at 10% yielded an increase of 6.6%. This showed that a higher incorporation of BNB90 would allow an increased thermal conductivity.

The transformation parameters proved to be stable, with a melt temperature of 202° C. under an average pressure of 275 psi. The RPM speed was maintained at 205 t/min with a power of 37 amp. The hourly throughput rate was 10 kg/h and then increased progressively to 25 kg/h.

In a further series of tests, tubes were fabricated and measures of thermal conductivity in the thickness (as defined by ASTM E1225-04) were taken by having a heat-transfer fluid flow through the sample tubes, which results are summarized in Table VI below:

TABLE VI
Thermal conductivity (½″ tubes)

| | | | | Ref | Composition | | | | Coupling | Conc- |
|---|---|---|---|---|---|---|---|---|---|---|
| Average K | Gain % | Density | Formula | CSTPQ | Hdpe | Hdpe | Pel | Graphite | agents | 099csa |
| — | — | — | — | — | 21 | 04 | 01 | KS 150 | L18307 | — |

| | | | | | | |
|---|---|---|---|---|---|---|
| 0.379 | 0.9532 | Vierge | A | 100% | 70% | 30% |

| | | | | | | | | | |
|---|---|---|---|---|---|---|---|---|---|
| 0.404 | 6.60% | 0.9962 | PEHD21 | D | 93.5% | | 10% | | 6.5% |
| 0.752 | 98.42% | 1.1392 | 1HG153 | B | | 70% | 30% | | |
| 0.752 | 98.42% | 1.1392 | 1HG153 | G | | 70% | 30% | | |
| 0.814 | 114.78% | 1.1700 | 1/AHG153 | C | | 63.50% | 30% | | 6.5% |
| 0.741 | 95.51% | 1.1505 | 1/AHG153 | H | | | | | |
| 0.753 | 98.68% | 1.1600 | 4HG153L | F | | 67.50% | 30% | 2.50% | |
| 0.791 | 108.71% | 1.1388 | 4HG153L | | | | | | |
| 0.608 | 60.42% | 1.0810 | 20CHNC73L | E | | 72.00% | 30% | 3.00% | |
| 0.593 | 56.46% | 1.0905 | 20CHNC73L | | | | | | |

As evidenced from the results of Table VI, the amount of graphite charges is to be selected, in a given combination of a resin, graphite charge type and compatibiliser, for a target thermal conductivity of the resulting composite.

Further tests were carried out to determine the percentage and dispersion of the graphite to be incorporated into HDPE to yield simultaneously target thermal conductivity and target mechanical properties.

The thermal conductivity was measured in the thickness (as defined by ASTM E1225-04), with results as shown in Table VII below:

TABLE VII

| | | | | | Transverse |
|---|---|---|---|---|---|
| HDPE | | | | | Thermal |
| (weight | | | Density | Load | conductivity |
| %) | Graphites | Type | (g/cm³) | (weight %) | (W/m/K) |
| 100 | | | | | 0.379 |
| 90 | KS 150 | particules | 0.42 | 10 | 0.404 |
| 80 | | | | 20 | 0.608 |
| 70 | | | | 30 | 0.77 |
| 66 | | | | 35 | 0.788 |
| 87 | KS 44 | particules | 0.19 | 13 | 0.48 |
| 90 | C-Therm | Densified/ | 0.15 | 10 | 0.58 |
| 85 | | exfoliated | | 15 | 0.679 |
| 80 | | | | 20 | 0.7 |
| 95 | BNB 90 | exfoliated | 0.03 | 5 | 0.515 |
| 80 | | | | 10 | 0.634 |
| 78 | | | | 12 | 0.674 |
| 80 | | | | 20 | 0.845 |
| 70 | | | | 30 | 1.24 |
| 65 | | | | 35 | 1.44 |

As can be seen form Table VII above, transverse thermals conductivity of at least 0.5 W/m/K is achieved with HDPE charged with as low as 5% exfoliated BNB 90.

C-Therm is a mixture of expanded graphite (such as BNB90) and densified graphite (such as KS150), which is characterized by a perfect flow not achievable with BNB90 alone. Superior thermal conductivity properties can be achieved at the cost of using large amounts (about 20.40%) of BNB90, which proves to be very expansive.

Mechanical tests were performed, in comparison with Versapipe® tubes which are well known (see Table VIII below). Nominal stress was measured as the pressure required to split the tube, as a function of the type of graphite:

TABLE VIII

| | | | | | | Post | |
|---|---|---|---|---|---|---|---|
| | | | | | | pressure | |
| | | | Average | | | average | |
| | | | external | Minimal | Residual | external | Nominal |
| Test | | Pressure | diameter | thickness | stress | diameter | stress |
| tube | Composition | (psi) | (mm) | (mm) | (psi) | (mm) | (psi) |
| B | Densified | 500 | 26.710 | 2.48 | 2443 | 26.695 | 543.5 |
| C | (20.4%) | 500 | 26.925 | 2.35 | 2614 | 27.100 | 581.7 |
| D | | 470 | 26.895 | 2.32 | 2489 | 26.945 | 553.9 |
| E | Exfoliated BNB | 650 | 26.580 | 2.33 | 3383 | 26.730 | 752.6 |
| F | 90 (12%) | 650 | 26.665 | 2.40 | 3286 | 26.800 | 731.1 |
| G | | 650 | 26.630 | 2.35 | 3358 | 26.765 | 747.1 |
| H | | 680 | 26.665 | 2.37 | 3485 | 26.770 | 775.5 |
| A | Prime HDPE | 650 | 26.330 | 2.70 | 2844 | 26.490 | 632.9 |

| | | | | | | |
|---|---|---|---|---|---|---|
| VERSA Pipe ® | 800 | 26.640 | 2.78 | 3433 | 29.010 | 763.9 |

As shown from Table VIII, using exfoliated graphite charges allows reaching increased mecanical resistance compared to using densified graphite charges, at a lower laoding rate.

Mechanical tests were also performed (see Table IX below) as a function of compounding parameters, using different primary compounds provided by different companies (ex.: Felix Composites, Centre de Technologie Minier et Plasturgiste de Thetford Mines CTMP).

PEHD37 refers to a composition based on Ctherm graphite. PEHD36 refers to a composition based on BNB90 graphite. M1, M2 and M3 refer to different tubes extruded from PEHD37. The ash content, measuring the amount of graphite left after calcination, was used to assess the amount of graphite in the tubes.

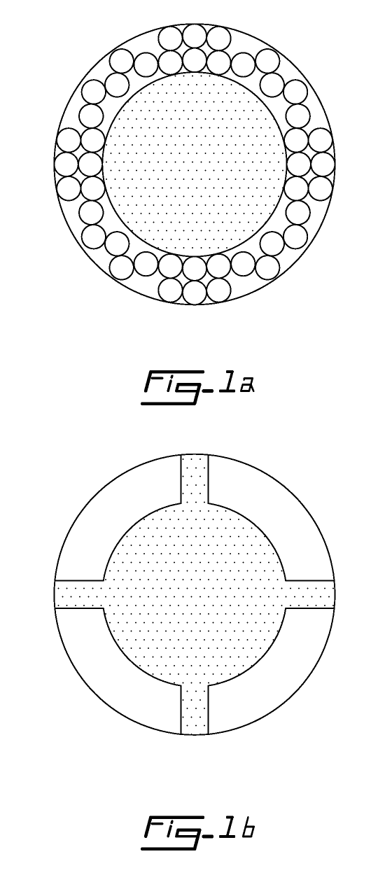

Different transition rings between the static mixer and the extruder head were tested, as shown for example in FIG. 1. FIG. 1a) shows a multi-aperture transition ring and FIG. 1b) shows a ring with blades, used to generate pressure variations that may have an impact on the distribution of the conductive charges in the extruded tubes.

As evidenced in Table IX below, using multi-aperture transition rings allows fabricating tubes having higher performances.

TABLE IX
Grades

| 0.1 | | | BNB90 |
|---|---|---|---|
| PEHD21/65% | PEHD21/88.5% | | Maleg |
| L18307/2.5% | L18307/1.5% | | |
| VISTA/2.5% | | | |
| 30% | 10% | 22.40% | |

| | | | | | | | | | Mechanical | Con- | Tran- | Ring |
|---|---|---|---|---|---|---|---|---|---|---|---|---|
| Ref: | PEHD37 | 13/07 | PEHD36 | PEHD- | Vistamax | orevac | GRAPHITE | Ash | resistance | ductivity | sition | with |
| resin | CTMP % | CTMP % | FELIX % | 21 % | % | 18307 % | % | % | of tube | tube | ring | blades |
| M1 | | | | | | | 20.70 | 19.8 | Acceptable | 0.69 | | X |
| | 69 | | | 30 | 0.20 | 0.80 | | | | | | |
| M2 | | | | | | | 21.00 | | Acceptable | 0.7 | | X |
| | 70 | | | 29 | 0.20 | 0.80 | | | | | | |
| M3 | | | | | | | 12.00 | | Acceptable | | | X |
| | 10 | 90 | | | | | | | | | | |
| H6 | | | 53 | | | | 11.87 | 11.92 | OK | 0.62 | X | |
| | | | | 45 | 0.20 | 1.80 | | | | | | |
| H7 | | | 54 | | | | 12.10 | 11.95 | OK | 0.65 | X | |
| | | | | 44 | 0.20 | 1.80 | | | | | | |
| H9 | | | 54 | | | | 12.10 | 11.85 | OK | 0.62 | | X |
| | | | | 44 | 0.20 | 1.80 | | | | | | |
| H10 | | | 58 | | | | 12.99 | 13.00 | Medium | 0.62 | | X |
| | | | | 40 | 0.20 | 1.80 | | | | | | |

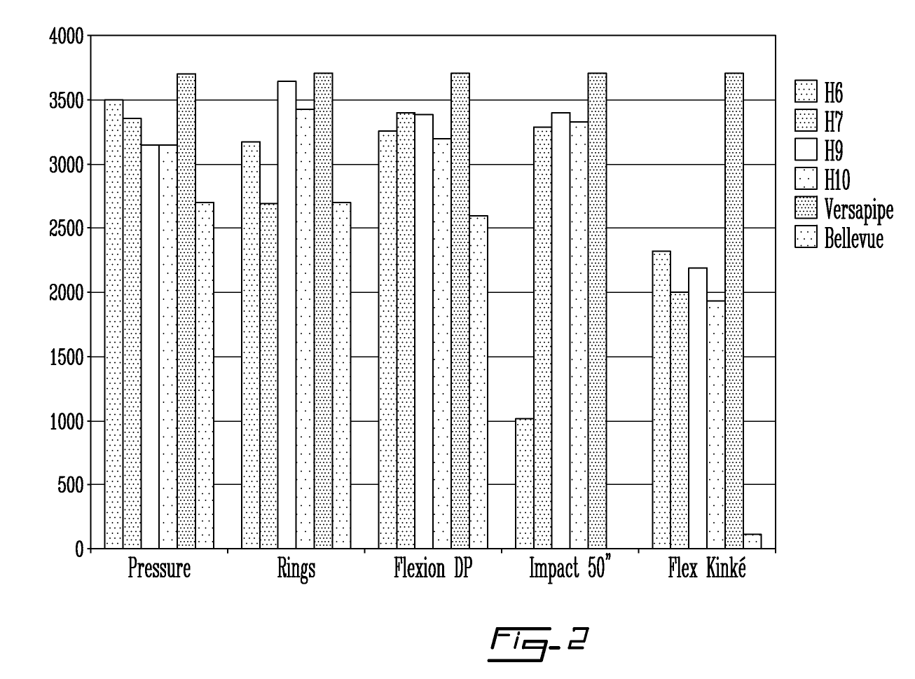

These rings are referred to as mixing elements in Table X below. FIG. 2 shows results of mechanical tests performed on test tubes of different compositions:

TABLE X

| | Graphite | | Orevac ® | PEHD | |
|---|---|---|---|---|---|
| | BNB90 | Vistamax ® | 18307 | 21 | Mixing |
| Compositions | (%) | (%) | (%) | (%) | element |
| H6: | 11.87 | 0.20 | 1.8 | 86.13 | no |
| H7 | 12.10 | 0.20 | 1.8 | 85.9 | no |
| H9 | 12.10 | 0.20 | 1.8 | 85 | yes |
| H10 | 13 | 0.20 | 1.8 | 83.5 | yes |

TABLE XI

| | |
|---|---|
| Versapipe ® | concentrated carbon black: 6.5% |
| | PEHD 21: 83.5% |
| Bellevue | Graphite Ctherm ® = 20.40% |
| (primary blend for composition | Vistamax ® = 0.20% |
| M1 see table above) | Orevac ® 18307 = 1.8% |
| | PEHD 21 = 77.6% |

Pressure tests were performed according to ASTM D1599 (Resistance to Short-Time Hydraulic Pressure of Plastic Pipe, Tubing, and Fittings): the samples are subjected to an increasing water pressure until they break: the pressure at break is then recorded.

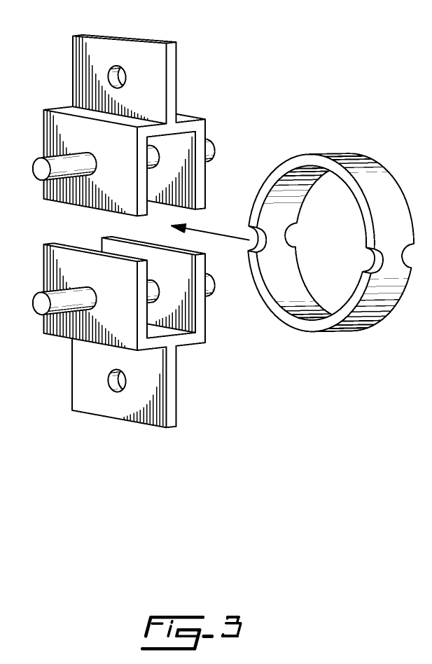

Traction tests were performed according to CSA B137 (Thermoplastic Pressure Piping) (see FIG. 3).

Impact tests were performed to assess the tubes resistance to impact (of a weight of 1 Kg from a 50″ height). Pressure tests under ASTM D1599 were performed after impact tests to assess the maximal pressure resistance after impact.

Resistances in flexion of the tubes were assessed using a visual test referred to as Flex Kinké. A 20″ sample is flexed until a wrinkling appears. Then the sample is examined for tearing (see FIG. 3).

As can be seen in FIG. 2 and Table X above, at a constant amount of impact modifier (Vistamax®) and compatibilizer (Orevac®).

Tensile bars made in HDPE with expanded graphite were submitted to accelerated photoaging in a SEPAP 12-24 chamber, to assess the behavior of the material to atmospheric conditions. Indeed, although the tubes are intended to be buried underground, they may be stored outdoors in the open air, before being installed, for periods of up to 5 or 6 months. The SEPAP 12-24 chamber generates conditions that reproduce, in an accelerated mode, chemical modifications that usually happen in the long term under natural aging, and which cause mechanical degradations by photo thermal oxidation. The results showed no stress raiser under conditions simulating continuous exposure (24/24 hours a day) to Arizona sunshine during 10 months.

Mechanical tests were performed on samples made of compositions HG153 and HG903 (See Tables XII en XIII below). 50C HG903L comprises 5% BNB90, and HG153L comprises KS150 graphite at 30%. The post letters S and W refer to an impact modifier used in amounts between 5 and 10%. C 099 CSA is a coloring agent based on carbon black.

TABLE XII

| | | Deformation | Modulus | Impact | Impact | | | | | | |
|---|---|---|---|---|---|---|---|---|---|---|---|
| | Modulus | at break | flexion | IZOD | Charpy | Shrinkage | Shrinkage | Shrinkage | | | Ash test |
| | % | % | % | % | % | % | % | % | Density | MELT | Ash content |
| 1 | 17 | −35 | 35 | −91 | −92 | 64 | −7 | −100 | 0.9824 | 4.7 | 9.9 |
| 2 | 11 | −38 | 34 | −92 | −91 | 57 | −50 | −100 | 0.9935 | 5.0 | 9.9 |
| 3 | −12 | −14 | 15 | −89 | −88 | 43 | −50 | −100 | 0.9818 | 4.7 | 8.9 |
| 4 | 18 | −6 | 28 | −88 | −86 | 101 | −20 | −100 | 0.9875 | 3.0 | 8.8 |
| 5 | 48 | −66 | 60 | −88 | −88 | 12 | −100 | −100 | 1.1307 | 6.2 | 30.0 |
| 6 | 63 | −66 | 59 | −90 | −89 | 14 | −100 | −100 | 1.1152 | 5.1 | 23.7 |
| 7 | 54 | −54 | 56 | −88 | −87 | 14 | −93 | −100 | 1.1272 | 5.5 | 29.3 |
| 9 | 4 | −29 | 13 | −82 | −83 | 0 | −20 | −10% | 1.0963 | 5.3 | 27.2 |
| 10 | 24 | −9 | 24 | −79 | −80 | 0 | 20 | −100 | 1.0578 | 2.6 | 25.8 |
| 11 | 0 | 0 | 0 | 0 | 0 | 0 | 0 | 0 | 0.9375 | 0.0 | 0.1 |
| 12 | 5 | −5 | −1 | −18 | −18 | 0 | 20 | 33 | 0.9434 | 0.1 | 0.8 |

| | Composition | | | | | | | |
|---|---|---|---|---|---|---|---|---|
| | % | % | % | | | | | |
| | 5OCHG903L | OCHG153L S | OCHG153L W | % OCHG153L | % PEHD21 | % PPC 69 | % Vistamax | % C 099 CSA |
| 1 | 100 | 0 | 0 | 0 | 0 | 0 | 0 | 0 |
| 2 | 99 | 0 | 0 | 0 | 0 | 0 | 0 | 0 |
| 3 | 93 | 0 | 0 | 0 | 0 | 0 | 7 | 0 |
| 4 | 90 | 0 | 0 | 0 | 10 | 0 | 0 | 0 |
| 5 | 0 | 0 | 0 | 100 | 0 | 0 | 0 | 0 |
| 6 | 0 | 0 | 0 | 99 | 0 | 0 | 0 | 0 |
| 7 | 0 | 0 | 0 | 93.5 | 0 | 0 | 0 | 6.5 |
| 9 | 0 | 0 | 100 | 0 | 0 | 0 | 0 | 0 |
| 10 | 0 | 100 | 0 | 0 | 0 | 0 | 0 | 0 |
| 11 | 0 | 0 | 0 | 0 | 100 | 0 | 0 | 0 |
| 12 | 0 | 0 | 0 | 0 | 95 | 0 | 0 | 0 |

Table XII indicates combinations that combine thermal conductivity and mechanical resistance.

The Charpy impact test, also known as the Charpy v-notch test, is a standardized high strain-rate test which determines the amount of energy absorbed by a material during fracture. This absorbed energy is a measure of a given material's toughness and acts as a tool to study temperature-dependent brittle-ductile transition.

Measurements were performed to assess shrinkage due to thermal contraction when molten material solidifies.

These results have been improved since, but it can already be seen in line 4 that the composition with only 10% PEHD-21 and 90% 50C HG903L (which is 5% BNB90) has a flexion modulus that is only 6% less than that of line 11, which is pure PE (100% PEHD-21), which thus corresponds to a deformation at break less than 850%.

Further tests on the same materials are shown in Table XIII below:

TABLE XIII

| | | | | | | | | ESCR ASTM | | HDT ASTM |
|---|---|---|---|---|---|---|---|---|---|---|
| | | | | | | | | D1693 | | D648:2006 |
| | Composition | | | | | | | 2008 | | Method A |
| | 5OCHG903L | OCHG153L S | OCHG153L W | OCHG153L | PEHD21 | Vistamax | C 099 CSA | Time | % break | ° C. |
| 1 | 100% | | | | | | | 0.1 | 100% | 70.4 |
| 2 | 99% | | | | | | | | | |
| 3 | 93% | | | | | 7% | | 21 | 100% | 63.9 |
| 4 | 90% | | | | 10% | | | | | |
| 5 | | | | 100% | | | | 0.1 | 100% | 85.4 |
| 6 | | | | 99% | | | | | | |
| 7 | | | | 94% | | | 7% | 01. | 100% | 80.5 |
| 9 | | | 100% | | | | | | | |
| 10 | | 100% | | | | | | 84 | 10% | 76.7 |
| 11 | | | | | 100% | | | 84 | 0% | 64.7 |
| 12 | | | | | 95% | | | 0.1 | 100% | 60.4 |

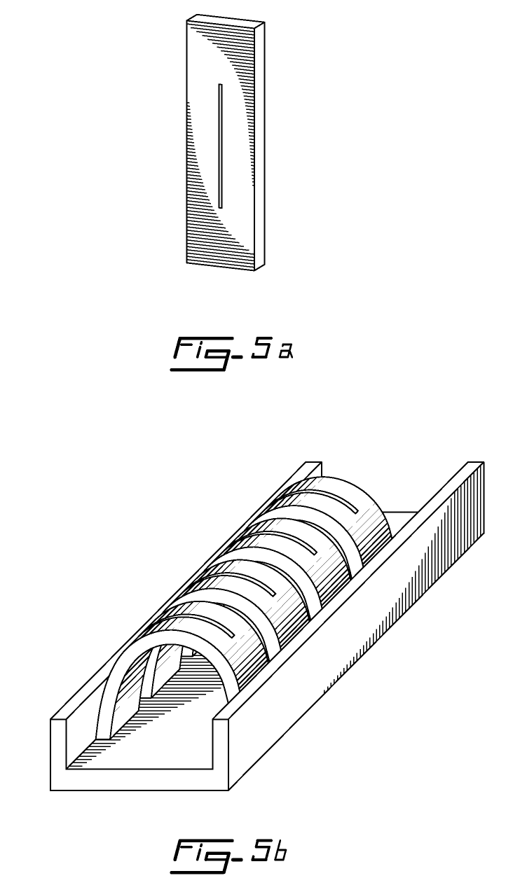

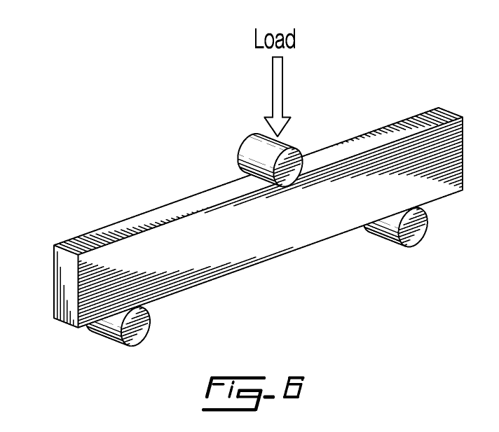

Resistance was assessed using Test Method for Environmental Stress-Cracking of Ethylene Plastics defined by ASTM D1693 (see FIG. 5), and Standard Test Method for Deflection Temperature of Plastics Under Flexural Load in the Edgewise Position defined by ASTM D648 (see FIG. 6).

In an aspect of the present invention, there is thus provided a conductive polymer composition, comprising a polymer such as HDPE, graphene charges, a compatibilizer and impact modifiers, having a transverse thermal conductivity of at about 0.5 W/m/K or more and a deformation at break about 850% or less (for example, as defined by ASTM D 638).

By adding additional charges of a different nature, tubes made in a composite comprising about 35% or less, for example about 30% or less, for example about 12% or less, for example down to about 5%, exfoliated graphite (density 0.03) may achieve thermal conductivity of at least 0.5 W/m/K and a deformation at break of about 850% or less.

In geothermal applications, such compositions allow fabricating heat exchangers with an increased thermal conductivity compared to the thermal conductivity of the resin from which these heat exchangers, such as pipes for example, are extruded. Indeed, the composites of the present invention have a thermal conductivity which may be 75% higher than that of the pristine polymer used, while having the desired mechanical properties. Such pipes reduce the thermal resistance of the well and reduce the length needed for geothermal heat exchangers, therefore greatly reducing system costs. It has been found that the well depth can be reduced by about 10%, or by 10 to 20% depending on the conductivity of the ground, therefore reducing system costs.

Although the present invention has been described hereinabove by way of specific embodiments thereof, it can be modified, without departing from the nature and teaching of the subject invention as described herein.

1. A thermally conductive polymer composition, comprising a polymer, conductive charges in an amount of about 35% by weight or less, and a compatibilizer, said composition having a transverse thermal conductivity of about 0.5 W/m/K or more and a deformation at break of about 850% or less.

2. The composition according to claim 1, wherein said polymer is polyethylene, polypropylene, poly(methyl methacrylate), polystyrene, polyamide, poly(butylene terephthalate), polycarbonate or acrylonitrile-butadiene-styrene copolymer, said conductive charges are metals, metal oxides, ceramics, minerals, carbon materials, aluminum, copper, aluminum oxide, magnesium oxide, boron nitride, graphite, carbon black or combinations thereof, said compatibilizer comprises maleic anhydride, calcium stearate, pentaerythritol stearate, impact modifiers or combinations thereof.

3. The composition according to claim 1, wherein said polymer is a polyolefin.

4. The composition according to claim 1, wherein said polymer comprises polyethylene, said conductive charges comprise exfoliated graphite in an amount of about 30% by weight or less, and said compatibilizer comprises maleic anhydride, calcium stearate, pentaerythritol stearate or combinations thereof.

5. The composition according to claim 1, wherein said polymer comprises polyethylene, said conductive charges comprise exfoliated graphite in an amount of about 12% by weight or less, and said compatibilizer comprises maleic anhydride, calcium stearate, pentaerythritol stearate or combinations thereof.

6. The composition according to claim 1, wherein said polymer comprises polyethylene, said conductive charges comprise exfoliated graphite in an amount of about 5% by weight or less, and said compatibilizer comprises maleic anhydride, calcium stearate, pentaerythritol stearate or combinations thereof.

7. The composition according to claim 1, wherein said polymer comprises polyethylene, said conductive charges comprise nanoparticles consisting of stacks of graphene that are about 1 to about 15 nanometers thick, with diameters ranging from sub-micrometer to about 100 micrometers.

8. A method for making a thermally conductive polymer composition having a transverse thermal conductivity of about 0.5 W/m/K or more and a deformation at break of about 850% or less, comprising the steps of:
i) feeding a polymer and a compatibilizer in a feed zone of an extruder to obtain a melted resin;
ii) introducing directly into the extruder, downstream of said feed zone, conductive charges in an amount of about 35% by weight or less into the melted resin; and
iii) providing a degassing zone before the output of the thermally conductive polymer composition produced.

9. The method of claim 8, wherein said step ii) comprises introducing about 30% by weight or less of said conductive charges into the melted resin.

10. The method of claim 8, wherein said step ii) comprises introducing about 12% by weight or less of said conductive charges into the melted resin.

11. The method of claim 8, wherein said step ii) comprises introducing about 5% by weight or less of said conductive charges into the melted resin.

12. The method of claim 8, wherein said step i) comprises feeding said polymer with maleic anhydride, calcium stearate, pentaerythritol stearate or combinations thereof.

13. The method of claim 8, wherein said step i) comprises feeding impact modifiers together with said polymer.

14. The method of claim 8, wherein said polymer is polyethylene, polypropylene, poly(methyl methacrylate), polystyrene, polyamide, poly(butylene terephthalate), polycarbonate or acrylonitrile-butadiene-styrene copolymer, said conductive charges are metals, metal oxides, ceramics, minerals, carbon materials, aluminum, copper, aluminum oxide, magnesium oxide, boron nitride, graphite, carbon black or combinations thereof, said compatibilizer comprises maleic anhydride, calcium stearate, pentaerythritol stearate, impact modifiers or combinations thereof.

15. The method of claim 8, wherein said polymer is HDPE, said conductive charges are exfoliated graphite, and said compatibilizer is maleic anhydride, calcium stearate, pentaerythritol stearate or a combination thereof.

16. A heat exchanger, made in a polymer composition comprising a polymer, conductive charges in an amount of about 35% by weight or less, and a compatibilizer, said heat exchanger having a transverse thermal conductivity of about 0.5 W/m/K or more and a deformation at break of about 850% or less.

17. The heat exchanger of claim 16, wherein said polymer is polyethylene, polypropylene, poly(methyl methacrylate), polystyrene, polyamide, poly(butylene terephthalate), polycarbonate or acrylonitrile-butadiene-styrene copolymer, said conductive charges are metals, metal oxides, ceramics, minerals, carbon materials, aluminum, copper, aluminum oxide, magnesium oxide, boron nitride, graphite, carbon black or combinations thereof, said compatibilizer comprises maleic anhydride, calcium stearate, pentaerythritol stearate, impact modifiers or combinations thereof.

18. The heat exchanger of claim 16, wherein said polymer is HDPE, said conductive charges are exfoliated graphite, and said compatibilizer is maleic anhydride, calcium stearate, pentaerythritol stearate or a combination thereof.
